(19) United States
(12) Patent Application Publication
(10) Pub. No.: US 2025/0146795 A1
(43) Pub. Date: May 8, 2025

(54) BALLISTIC GLASS AND ASSOCIATED METHODS AND ASSEMBLIES

(71) Applicant: Armitek LLC, Orem, UT (US)

(72) Inventors: Dean Casutt, Spanish Fork, UT (US); Bryant Casutt, Spanish Fork, UT (US); Aaron K. Gilbert, Spanish Fork, UT (US)

(21) Appl. No.: 19/015,212

(22) Filed: Jan. 9, 2025

Related U.S. Application Data
(63) Continuation of application No. 17/093,376, filed on Nov. 9, 2020.

(51) Int. Cl. F41H 5/04; B32B 17/10; F41H 5/26

(52) U.S. Cl. CPC F41H 5/0407; B32B 17/10018; B32B 17/10366; B32B 17/10752; B32B 17/10779; B32B 17/10908; B32B 2307/558; B32B 2605/006; F41H 5/26

(57) ABSTRACT

A ballistic glass assembly including a first glass layer and a second layer including a polyethylene terephthalate (PET) adhesive film. The ballistic glass assembly may also include an intermediate layer comprising a substantially transparent impact resistant material positioned between the first layer and the second layer. Methods of forming the ballistic glass assembly where the second layer and the intermediate layer match the contour of the first glass layer.

### CROSS-REFERENCE TO RELATED APPLICATION

This application is a continuation of U.S. patent application Ser. No. 17/093,376, filed Nov. 9, 2020, the disclosure of which is hereby incorporated herein in its entirety by this reference.

### TECHNICAL FIELD

Embodiments of the present disclosure generally relate to glass. In particular, embodiments of the present disclosure relate to ballistic glass, to associated methods of manufacturing ballistic glass, and to assemblies for manufacturing ballistic glass.

### BACKGROUND

Ballistic glasses are used to protect people in vehicles, such as ground assault vehicles, personnel transportation, railcars, aircraft, among others, as well as buildings and other structures, such as houses, buildings, bunkers, and so forth, from ballistics. Ballistics may include, for example, projectiles such as bullets, shrapnel and/or waves generated by nearby explosions, among others.

Ballistic glasses commonly comprise a laminated structure of multiple materials, and typically include multiple layers or sheets of glass, plastic, resin, and/or other hard or resilient/elastic materials, which typically must remain transparent to visible light. When a ballistic projectile hits a ballistic glass, the plate (e.g., a glass sheet) of the ballistic glass exposed to the impact must withstand the perforation by the ballistic projectile, while the opposite side plate (e.g., a resilient layer such as a polymer layer) should stop fragments of the projectile and the exposed plate from penetrating completely through the ballistic glass. For example, most ballistic glass can be characterized as having an exterior side (e.g., strike side, the side of the ballistic glass that will be exposed to ballistic projectiles when used in, for example, armored vehicles), and an interior side (the side of the ballistic glass that will be facing, for example, a cockpit or passenger cabin of a plane or ground vehicle).

### BRIEF SUMMARY

Embodiments of the present disclosure may include a ballistic glass assembly including a first layer including glass. The ballistic glass assembly may further include a second layer including a polyethylene terephthalate (PET) film. The ballistic glass assembly may also include an intermediate layer comprising a substantially transparent and impact resistant material positioned between the first layer and the second layer.

Other embodiments of the present disclosure may include a method of manufacturing ballistic glass. The method may include creating a form tool configured to match a shape and contour of a piece of glass. The method may further include forming a deck comprising multiple layers. At least one layer may include a polyethylene terephthalate (PET) material. The method may also include matching a contour of the deck to a contour of the piece of glass by connecting the deck to the form tool with a high volume vacuum. The method may further include coupling the piece of glass to the deck with an adhesive.

Other embodiments of the present disclosure may include a method of manufacturing ballistic automotive glass. The method may include forming a deck comprising multiple layers. At least one layer may include a polyethylene terephthalate (PET) material. The method may further include coupling the deck to a section of automotive glass with an adhesive. One or more spacers may define a void between the deck and the section of automotive glass. The method may also include filling the void with a liquid laminate material. The method may further include curing the liquid laminate material under a negative pressure.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a schematic view of a ballistic glass assembly in accordance with an embodiment of the present disclosure;

FIGS. 2A and 2B illustrate a process step of forming a ballistic glass assembly in accordance with an embodiment of the present disclosure;

FIGS. 3A and 3B illustrate a process step of forming a ballistic glass assembly in accordance with an embodiment of the present disclosure;

FIG. 4 illustrates a schematic view of a deck in accordance with an embodiment of the present disclosure;

FIG. 5 illustrates a process step of forming a ballistic glass assembly in accordance with an embodiment of the present disclosure;

FIG. 6 illustrates a process step of forming a ballistic glass assembly in accordance with an embodiment of the present disclosure;

FIG. 7 illustrates a process step of forming a ballistic glass assembly in accordance with an embodiment of the present disclosure;

FIG. 8 illustrates a flow chart representative of a method of forming a ballistic glass assembly in accordance with an embodiment of the present disclosure; and

FIG. 9 illustrates a schematic view of a process step of forming a ballistic glass assembly in accordance with an embodiment of the present disclosure.

### DETAILED DESCRIPTION

The illustrations presented herein are not meant to be actual views of any particular ballistic glass assembly, associated tool, or components thereof, but are merely idealized representations employed to describe illustrative embodiments. The drawings are not necessarily to scale.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

In some cases, ballistic glass may be incorporated into a vehicle that was mass produced without the intention of equipping the vehicle with ballistic glass. For example, the windows of a mass produced vehicle may be replaced with windows made of ballistic glass. The mass produced vehicle may not be designed to incorporate the ballistic glass. In some cases, the ballistic glass may be substantially heavier and/or thicker than the original equipment manufacturer (OEM) windows provided with the mass produced vehicle. Heavier and/or thicker glass may require modifications to the vehicle, such as modifications to window hardware, such as window channels, window regulators, window motors, etc. Ballistic glass having reduced weight and/or thickness may enable ballistic glass to be fitted to a mass produced vehicle with fewer modifications to the vehicle, which may reduce the cost of fitting ballistic glass to a mass produced vehicle. In some cases, reducing the weight of the ballistic glass may further improve fuel economy and power to weight ratios for the associated vehicle.

In some cases, the OEM windows may be curved (e.g., the plane of the glass may define a curvature, such as a dome, a dish, or complex curvature or contour). The conventional methods used to produce ballistic glass may not be amenable to producing ballistic glass matching the curvatures of OEM windows. Producing ballistic glass matching the curvatures of OEM windows may enable the ballistic glass to be fitted to a mass produced vehicle with little to no modifications to the vehicle. In some cases, ballistic glass that matches the curvatures of OEM windows may improve seals between the ballistic glass and the body of the mass produced vehicle. In some cases, ballistic glass that matches the curvatures of OEM windows may enable doors and/or windows of the mass produced vehicle to open and close in a smooth manner. Ballistic glass that matches the curvatures of OEM windows may further improve aesthetics of the mass produced vehicle by maintaining the vehicle lines and curves in a substantially original form. In some cases maintaining the vehicle lines and curves may allow an end user to conceal the fact that the vehicle includes ballistic glass.

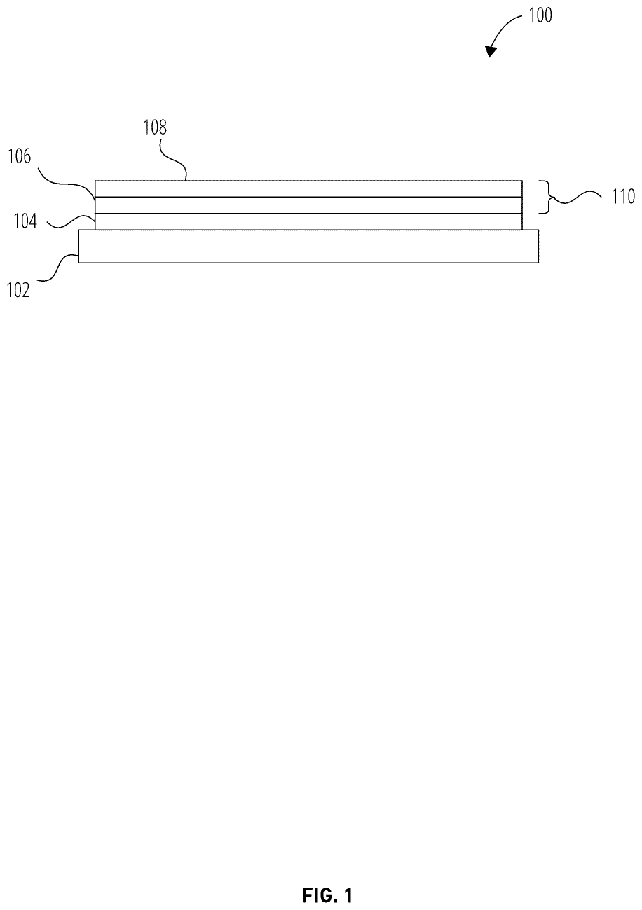

FIG. 1 illustrates a schematic view of a ballistic glass assembly 100 in accordance with some embodiments of the present disclosure. The ballistic glass assembly 100 may include a layer of glass 102, and a multi-layer deck 110 of layered polymeric materials, glass material, and/or ceramic material (e.g., aluminum oxynitride) adhered to the glass 102 by an adhesive layer 104. As a non-limiting example, the multi-layer deck 110 may comprise an optional impact resistant layer 106 and at least one polymer sheet layer 108 of a polymer material having a composition selected to absorb energy after initial impact of a projectile with the glass 102 without shattering or allowing particles of the projectile to pass through the ballistic glass assembly 100.

The layer of glass 102 may be configured to be an exterior layer of the ballistic glass assembly 100. The glass 102 may be a conventional automotive safety glass comprising one or more layers of tempered silicate glass, annealed glass, or annealed laminate glass laminated with a polymer film. In some embodiments, the glass 102 may be an OEM window from the vehicle being fitted with ballistic glass. For example, the glass 102 may be an OEM replacement window for the vehicle or an original equipment window (e.g., the original window from the car), etc. The glass 102 may have a thickness between about 0.14 inches (in) (3.556 millimeter (mm)), such as between about 0.18 in (4.572 mm) and about 0.22 in (5.588 mm), such as about 0.20 in (5.08 mm). In some embodiments, the glass 102 may be formed and/or bent to the desired shape. For example, the glass 102 may be formed from a glass having a greater thickness than the OEM window to substantially match a shape and curvature of the OEM window. The glass 102 may include a hard coating material, such as a windshield coating. The windshield coating may be an extremely hard coating on an outer surface of the glass 102 that is configured to shrink to fit around significant curves without wrinkling when exposed to heat.

The multi-layer deck 110 may include one or more polymer sheet layers 108. In some embodiments, each polymer sheet layer 108 may comprise one or more materials selected from among polyethylene, polyester, polycarbonate, polytetrafluoroethylene (PTFE), perfluoroalkoxy polymer (PFA), fluorinated ethylene propylene (FEP), ethylene tetrafluoroethylene (ETFE), etc. In some embodiments, the polymer sheet layers 108 may include one or more layers of a polyethylene terephthalate PET film. PET is a thermoplastic polyester that may be amorphous, crystalline, or a mixture of both depending on how the PET is produced. For example, the PET film may be a material such as ASWF Safety & Security Window Film sold by the American Standard Window Film company of Las Vegas, Nevada. In some embodiments, the polymer sheet layers 108 may be coated with an adhesive on one or both major surfaces thereof during formation of the multi-layer deck 110, as is discussed in further detail hereinbelow. For example, the adhesive applied to one or both surfaces of each polymer sheet layer 108 may be a pressure sensitive polyester adhesive material. In some embodiments, the adhesive may be an adhesive film such as polyurethane adhesive films. For example, the adhesive film may be a product such as COLLANO® sold by PONTACOL® of Switzerland. In some embodiments, the polymer sheet layers 108 may be melted during the forming process adhering the adjoining layers without an additional applied adhesive.

The polymer sheet layer 108 may allow greater than about 80% of visible light to be transmitted through the polymer sheet layer 108, such as greater than about 85% of visible light, greater than about 89% of visible light or greater than about 90% of visible light. Each layer of the polymer sheet layer 108 may have a tensile strength of between about 30,000 pounds per square inch (psi) (206.843 megapascals (MPa)) and about 35,000 psi (241.317 MPa), such as between about 31,000 psi (213.737 MPa) and about 33,000 psi (227.527 MPa), or about 32,000 psi (220.632 MPa). Each layer of the polymer sheet layer 108 may have a break strength between about 110 pounds per linear inch (pli) (19.264 kilo-Newtons/meter (kN/m)) and about 650 pli (113.832 kN/m), such as between about 300 pli (52.538 kN/m) and about 585 pli (102.449 kN/m), or about 440 pli (77.056 kN/m). The polymer sheet layer 108 may have a puncture strength of greater than about 65 pounds (lb) (289.134 Newtons (N)), such as between about 65 lb (289.1343 N) and about 335 lb (1,490.15 N), between about 215 lb (956.368 N) and about 300 lb (1,334.47 N) or about 275 lb (1,223.26 N).

Each layer of the polymer sheet layer 108 may have a thickness between about 0.010 in (0.254 mm) and about 0.024 in (0.610 mm), such as about 0.016 in (0.4064 mm). For example, a layer of PET film may have a thickness between about 0.010 in (0.254 mm) and about 0.024 in (0.610 mm), such as about 0.016 in (0.4064 mm). The PET film may include multiple thin layers of PET material, such as multiple layers of PET material having a thickness of about 0.001 in (0.0254 mm) bonded together with an adhesive to form the PET film. In some embodiments, the polymer sheet layer 108 may be formed from multiple layers of PET film, such as from two layers of PET film to about ten layers of PET film, or from three layers of PET film to six layers of PET film.

The multi-layer deck 110 may also include the optional impact resistant layer 106. The impact resistant layer 106 may be formed from an impact resistant material. In some embodiments, the impact resistant material may be a thermoplastic material, such as a polycarbonate material, an acrylic material (e.g., polymethyl methacrylate), acrylic glass, etc. In some embodiments, the polycarbonate material or the acrylic material may include polymers, such as polyethylene, polypropylene, polyvinyl chloride, acrylonitrile butadiene styrene, etc. In other embodiments, the impact resistant layer 106 may comprise an optically transparent ceramic material, such as aluminum oxynitride, for example.

Polycarbonate material is a thermoplastic polymer including carbonate groups in the chemical structures. Carbonate groups (—O—(C═O)—O—) are a molecular group featuring both a short O═C bond (e.g., in the range of about 1.1 Å) and one or more slightly longer C—O bonds (e.g., in the range of about 1.3 Å). The carbonate groups may increase a rigidity and/or strength of the associated material.

Polycarbonate materials may have a tensile strength of between about 8,000 psi (55.158 MPa) and about 11,000 psi (75.842 MPa), such as between about 9,000 psi (62.053 MPa) and about 10,000 psi (68.948 MPa) or about 9,500 psi (65.500 MPa). Polycarbonate materials may have a compressive strength greater than about 11,000 psi (75.842 MPa), such as greater than about 12,000 psi (82.737 MPa) or about 12,500 psi (86.184 MPa). Polycarbonate materials may have a notched Izod impact strength of between about 11 foot-pound/inch (ft-lb/in) (587.165 joule/meter (J/m)) and about 20 ft-lb/in (1067.57 J/m), such as about 18 ft-lb/in (960.816 J/m). Commercially available polycarbonate materials include, for example, TUFFAK® sold by PLASKOLITE®.

The optional impact resistant layer 106 may comprise any other optically transparent material that exhibits one or more similar physical properties to those exhibited by polycarbonate materials.

The optional impact resistant layer 106 may have a thickness between about 0.0625 in (1.5875 mm) and about 0.500 in (12.70 mm), such as between about 0.100 in (2.54 mm) and about 0.200 in (5.08 mm) or about 0.125 in (3.175 mm).

The impact resistant layer 106, and the polymer sheet layers 108 may combine to form the deck 110. The deck 110 may be the elements added to a window to achieve the desired ballistic properties when assembled with the glass 102. The deck 110 may be formed by laminating the various layers of the deck 110 together and then attaching the deck 110 to the glass 102 using the adhesive layer 104, or by sequentially applying the layers of the deck 110 on an interior side of the glass 102. The interior side of the glass 102 may be the side of the glass 102 facing the interior of a vehicle or building (e.g., cockpit, vehicle interior, etc.). In some embodiments, the deck 110 may be oriented such that the optional impact resistant layer 106 is positioned between the glass 102 and the polymer sheet layers 108. In other embodiments, the optional impact resistant layer 106 may be on a side of the polymer sheet layers 108 opposite the glass, or optional impact resistant layers 106 may be disposed on both sides of the polymer sheet layers 108, or even embedded within and between the polymer sheet layers 108. The deck 110 may include additional layers of polycarbonate material, polymer sheets, glass, and/or additional materials having properties configured to increase impact resistance, penetration resistance, etc., of the deck 110.

The adhesive layer 104 may be applied between the glass 102 and the deck 110 as a liquid and subsequently cured to form the adhesive layer 104, as described in further detail herein. In some embodiments, the adhesive layer 104 may be a sheet of polymer material, such as polyethylene terephthalate (PET), etc., coated on both sides with an adhesive, as described previously herein. In other embodiments, the adhesive layer 104 may be an adhesive film such as polyurethane adhesive films. For example, the adhesive film may be a product such as COLLANO® sold by PONTACOL®. The adhesive layer 104 is configured to adhere the layer of glass 102 to the deck 110. For example, an adhesive film may be positioned between two the layer of glass 102 and the deck 110 and cured through high temperatures and/or pressures, such as in an autoclave, to adhere the layer of glass 102 to the deck 110.

In some embodiments, the adhesive layer 104 may be formed from a clear epoxy resin. For example, the adhesive layer 104 may be formed from a two part urethane resin, such as POLYLAM™ sold by GLASSLAM™. In some embodiments, the adhesive layer 104 may be formed from a two part polyester resin. The resin forming the adhesive layer 104 may be chosen for properties, such as adhesion, clarity, color, tint, etc. In some embodiments, the resin may initially be a liquid material that is configured to cure through a chemical reaction resulting from mixing two compounds together. In some embodiments, the resin may initially be a liquid material that is configured to cure from exposure to heat and/or UV light.

The adhesive layer 104 may have a thickness between about 0.010 in (0.254 mm) and about 0.070 in (1.778 mm), such as between about 0.016 in (0.4064 mm) and about 0.055 in (1.397 mm). In some embodiments, the adhesive layer 104 may be formed from one or more layers of adhesive sheets. The adhesive sheets may have a thickness between about 0.010 in (0.254 mm) and about 0.020 in (0.508 mm), such as about 0.016 in (0.4064 mm). In some embodiments, the adhesive layer 104 may be formed from multiple adhesive sheets.

In some embodiments, the adhesive layer 104 may be substantially transparent, such that the adhesive layer 104 may not adversely affect visibility through the ballistic glass assembly 100. In some embodiments, the adhesive layer 104 may be configured to alter light passing through the ballistic glass assembly 100. For example, the adhesive layer 104 may be configured to filter ultraviolet (UV) light. In some embodiments, the adhesive layer 104 may be a tinted material configured to reduce an amount of visible light passing through the ballistic glass assembly 100.

The different layers of material in the ballistic glass assembly 100 may perform different functions in achieving the desired ballistic properties of the ballistic glass assembly 100. For example, the glass 102 and the optional impact resistant layer 106 may have a primary role of causing the projectile to break apart and reduce momentum of moving fragments. The slowed projectile and/or fragments of the projectile may then be captured (e.g., stopped, caught, etc.) by the polymer sheet layers 108. Fragmented pieces of the glass 102 and the impact resistant layer 106 may be created by the impact of the projectile. The polymer sheet layers 108 may be configured to capture any such pieces of the glass 102, the impact resistant layer 106, and/or the projectile that may pass through the impact resistant layer 106. In some cases, the polymer sheet layers 108 may also be configured to maintain the structural integrity of the glass 102 and the impact resistant layer 106. For example, after the ballistic glass assembly 100 has absorbed multiple projectile impacts, the polymer sheet layers 108 may substantially prevent larger pieces of the glass 102 and/or the impact resistant layer 106 from dislodging from the respective layers, such that the layer of glass 102 and the impact resistant layer 106 remain substantially intact to absorb additional projectile impacts.

In some embodiments, additional layers may be present in the ballistic glass assembly 100. For example, as previously mentioned, an additional impact resistant layer 106 may be applied to an opposite side of the polymer sheet layers 108 from the first impact resistant layer 106, such that the polymer sheet layers 108 are sandwiched between two impact resistant layers 106. In some embodiments, an additional layer of glass 102 having a similar shape and size to the deck 110 may be included anywhere in the ballistic glass assembly 100, but preferably exterior to at least a portion of the polymer sheet layers 108.

A fully assembled ballistic glass assembly 100 may be less than about 0.75 in (19.05 mm) thick, such as between about 0.200 in (5.08 mm) thick and about 0.75 in (19.05 mm), or between about 0.400 in (10.16 mm) and about 0.600 (15.24 mm) thick.

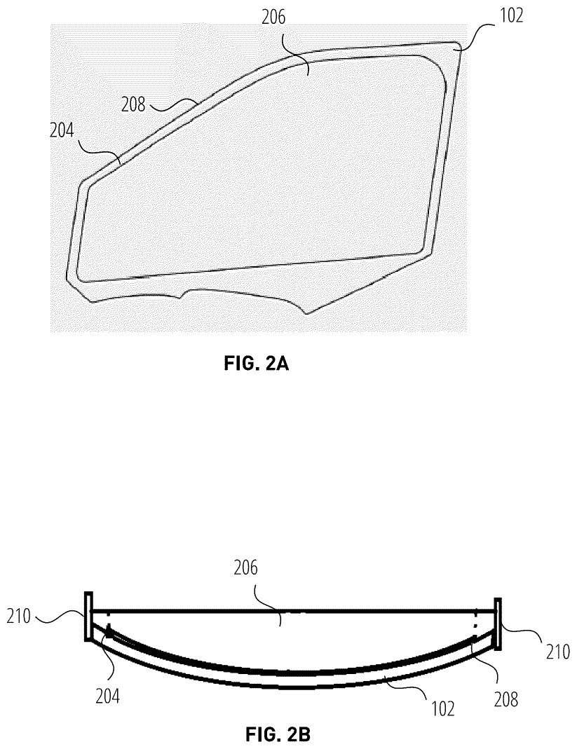

Additional embodiments of the present disclosure include methods of forming a ballistic glass assembly 100, as described herein. FIGS. 2A-7 illustrate process steps of forming a ballistic glass assembly 100 for an automobile window. First, the automobile window glass 102 may be selected. As described above, the glass 102 may be an OEM automobile window, such as an OEM replacement window or an original equipment window. The glass 102 may be configured to fit into the guides, rails, regulators, channels, etc., of the associated automobile. When the glass 102 is rolled up in the associated automobile, some portions of the glass 102 may be covered by the window frame. To ensure proper fitment of the glass 102, the deck 110 may be isolated to the portions of the glass 102 that are not covered by the window frame and/or the window seals when the window is rolled up.

A border 204 may be defined on the glass 102. For example, the border 204 may be drawn onto the window using a marker, paint, etc. In some embodiments, the border 204 may be defined in a computer program as coordinates, angles, line dimensions, radii, etc. The border 204 may define a separation between the portions of the glass 102 that are covered by the window frame and/or window seals of the automobile and the portions of the glass 102 that are not covered by the window frame and/or window seals. The border 204 may be used to create or extrapolate a template. For example, the template may enable multiple ballistic glass assemblies 100 for a particular window (e.g., window associated with a specific vehicle make, model, year, and window position) to be formed without drawing the border 204 on each piece of glass 102.

A form tool 206 may be created for the portions of the glass 102 that are not covered by the window frame of the automobile. The form tool 206 may be formed by creating form walls 210 along an outer edge 208 of the glass 102. The form walls 210 may be formed from a flexible material, such as a thermoplastic material (e.g., polyvinyl chloride (PVC), polyethylene, polypropylene, polystyrene, etc.,) attached to the outer edge 208 of the glass 102 with an adhesive, such as double sided tape, glue, etc. In some embodiments, the form walls 210 may be reinforced with additional materials, such as polymer materials (e.g., polypropylene, polyester, etc.), sealants (e.g., silicone, polysiloxane, etc.), etc. The form walls 210 may have a thickness of at least about 0.125 in (3.175 mm).

Once the form walls 210 are created, the glass 102 may be coated with a release agent. A mold release agent may be a film configured to prevent adhesion between the glass 102 and a material used to create the form tool 206. The release agent may be applied through a spraying process or a direct application, such as brushing or rolling.

After the release agent is applied, the form tool 206 may then be built up within the form walls. For example, the form tool 206 may be formed from a rigid foam, such as a rigid urethane foam, a rigid polyurethane foam, a rigid silicone foam, etc. The rigid foam may be mixed in a liquid form from multiple components and poured into the area defined by the form walls and the glass 102 while in liquid form. The foam may then be allowed to harden creating the form tool 206 at a thickness of between about 1 in (25.4 mm) and about 3 in (76.2 mm), such as between about 1.5 in (38.1 mm) and about 2 in (50.8 mm). In some embodiments, the form tool 206 may be formed from a composite material, such as fiber glass or carbon fiber built up as layers of fiber and resin within the area defined by the form walls and the glass 102 and allowed to cure forming a rigid structure defining the form tool 206. In other embodiments, the form tool 206 may be formed from a rubber molding material.

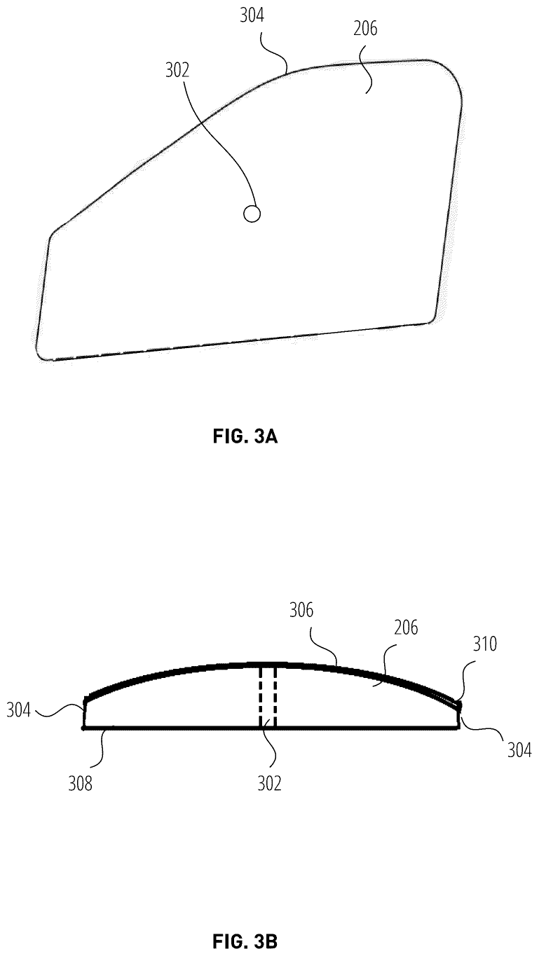

Once the form tool 206 is cured or hardened, the form tool 206 may be removed from the area defined by the form walls and the glass 102. FIG. 3A illustrates a plan view of the form tool 206 and FIG. 3B illustrates a profile view of the form tool 206 separated from the glass 102. The form tool 206 may be trimmed such that an outer edge 304 of the form tool 206 is substantially the same as the border 204 defined by the window frame discussed with reference to FIG. 2A. In some embodiments, an inner deck template may be created from the border 204 and used to mark the form tool 206, such that the form tool 206 may be trimmed to substantially the same size and shape as the border 204. In some embodiments, properties of the border 204, such as size, shape, orientation, dimensions, angles, radii, etc., may be digitally recorded. The properties of the border 204 may then be used to control a computer controlled cutting mechanism, such as a water jet, laser cutter, computer numerical control (CNC) machine (e.g., CNC mill, CNC router, etc.), wire electrical discharge machining machine (wire EDM), etc., to cut the form tool 206 to substantially the same size and shape as the border 204. In some embodiments, the form tool 206 may be cut to substantially the same size and shape as the border 204, through another cutting mechanism, such as a hand tool, saw, power saw, mill, etc.

The form tool 206 may include a front surface 306 and a rear surface 308. The front surface 306 of the form tool 206 may be the surface of the form tool 206 that was formed against the glass 102. The front surface 306 may be complementary to the curvature of the glass 102 (e.g., have a complementary contour to the glass 102). The rear surface 308 may be a side of the form tool 206 that was formed opposite the glass 102. In some embodiments, the rear surface 308 may be substantially flat. In some embodiments, the rear surface 308 may be configured to interface with other components, such as tooling (e.g., for securing the form tool 206).

One or more holes 302 may be formed in a central region of the form tool 206. The one or more holes 302 may pass from the rear surface 308 to the front surface 306. In some embodiments, the one or more holes 302 may be formed through the same process as the outer edge 304 is trimmed. For example, the one or more holes 302 may be formed by the computer controlled cutting mechanism. In some embodiments, the one or more holes 302 may be formed after the outer edge 304 is trimmed. For example, the one or more holes 302 may be drilled using a manually operated drill, such as a hand drill, a drill press, etc. In some embodiments, the holes 302 may be formed before the outer edge 304 is trimmed using one or more of above mentioned processes.

In some embodiments, a single hole 302 may be formed in substantially the center of the form tool 206 as illustrated in FIG. 3A. In some embodiments, a pattern of holes 302 may be formed in a central area of the form tool 206. In some embodiments, a pattern of holes 302 may be formed such that a hole 302 is formed in several different regions of the form tool 206. A major dimension (e.g., diameter, apothem, length, width, etc.) of the holes 302 may be between about 0.25 in (6.35 mm) and about 0.5 in (12.7 mm), such as between about 0.375 in (9.525 mm) and about 0.5 in (12.7 mm) or about 0.4375 in (11.1125 mm).

In some embodiments, the holes 302 may be configured to receive pneumatic fittings (e.g., vacuum fittings). For example, the holes 302 may include threads configured to receive a threaded pneumatic fitting. In some embodiments, the holes 302 may be at least partially filled with a sealing material configured secure and/or form a seal around a pneumatic fitting. For example, the holes 302 may be at least partially filled with a silicone adhesive configured to form a seal around the pneumatic fitting and secure the pneumatic fitting in the one or more holes 302. In some embodiments, an interface between the one or more holes 302 and the pneumatic fittings may form an interference fit (e.g., compression fit, press fit, etc.) configured to secure and/or seal the pneumatic fittings in the one or more holes 302. In some embodiments, the pneumatic fittings may be secured and/or sealed in the one or more holes 302 using a combination of interfaces and/or interfacing materials.

In some embodiments, the form tool 206 may include a coating 310, such as a hardened coating or a smooth coating. The coating 310 may be applied over the front surface 306 of the form tool 206. The coating 310 may include a mixture of an epoxy and acetone that may form a smooth surface on the front surface 306 of the form tool 206.

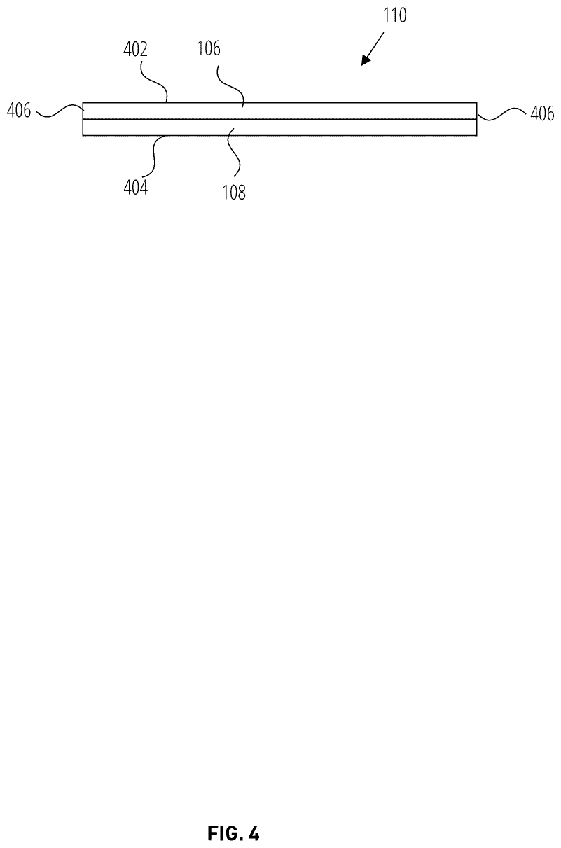

A deck 110 may be constructed as illustrated in FIG. 4. The deck 110 may include an optional impact resistant layer 106 and one or more polymer sheet layers 108. The polymer sheet layers 108 and the impact resistant layer 106 may be laminated together using adhesive and applied pressure and/or heat. For example, an adhesive activated by one or more of pressure and temperature may be applied to one or both surfaces to be bonded to one another. In some embodiments, heated nip rollers may be used to laminate the various layers of the polymer sheet layers 108 and the impact resistant layer 106. For example, the heated nip rollers may be heated to a temperature of between about 120° F. (48.889° C.) and about 220° F. (104.4440° C.), such as between about 150° F. (65.556° C.) and about 200° F. (93.333° C.) or about 180° F. (82.222° C.). A constant pressure may be applied between the rollers, such as between about 20 pounds per linear inch (PLI) (3502.54 newton/meter (N/m)) and about 50 PLI (8756.34 N/m), between about 20 PLI (3502.54 N/m) and about 30 PLI (5253.81 N/m), such as about 26.13 PLI (4576.06 N/m). In some embodiments, the heat and/or pressure may be applied through another means, such as a flat press, a heated flat press, etc. In some embodiments, the pressure and heat may be applied separately. For example, heat may be applied through a separate heating means, such as a heater, heat gun, furnace, oven, heat lamp, etc., while the pressure may be applied by a press, a roller, roller press, flat press, etc.

Once assembled, the impact resistant layer 106 may define a front surface 402 of the deck 110 and the polymer sheet layers 108 may define a back surface 404 of the deck 110. The deck 110 may be cut along an outer edge 406 of the deck 110 such that the deck 110 is substantially the same size and shape as the border 204 defined by the window frame discussed in FIG. 2A. In some embodiments, an inner deck template may be created from the border 204 and used to mark the outer edge 406 of the deck 110, such that the deck 110 may be trimmed to substantially the same size and shape as the border 204. In some embodiments, properties of the border 204, such as size, shape, orientation, dimensions, angles, radii, etc., may be digitally recorded. The properties of the border 204 may then be used to control a computer controlled cutting mechanism, such as a water jet, laser cutter, CNC machine (e.g., CNC mill, CNC router, etc.), wire EDM, etc., to cut the deck 110 to substantially the same size and shape as the border 204.

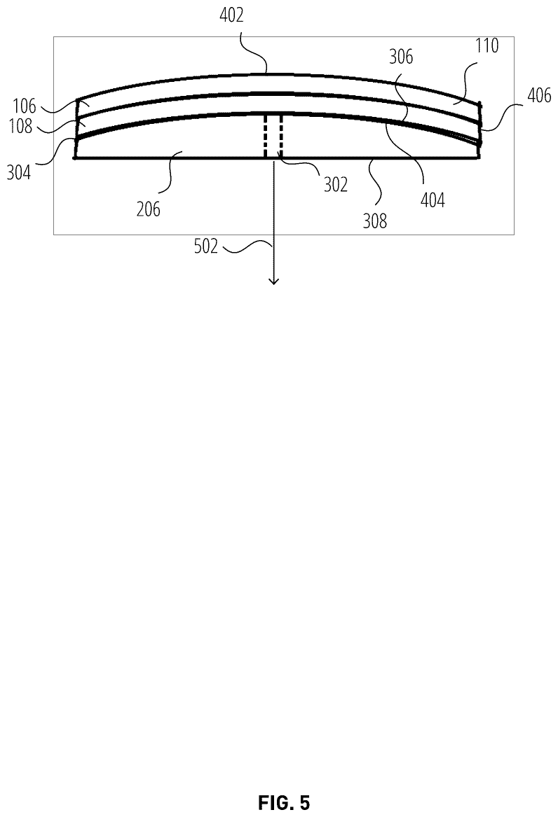

Once the deck 110 is formed and shaped, the deck 110 may be placed on the form tool 206 as shown in FIG. 5. The back surface 404 of the deck 110 may be positioned adjacent to the front surface 306 of the form tool 206. As described above, the front surface 306 of the form tool 206 may be substantially complementary to the curvature of the glass 102. The form tool 206 may include a thin seal along the outer edge 304 of the form tool 206. The thin seal may be configured to create an air tight seal between the front surface 306 of the form tool 206 and the back surface 404 of the deck 110. In some embodiments, the thin seal may be formed from a silicone material forming a small bead around the outer edge 304 of the form tool 206.

A vacuum 502 may be applied to the one or more holes 302 in the form tool 206. The vacuum 502 may be generated by a high volume vacuum, such as a high volume vacuum pump. The high volume vacuum may be coupled to the one or more holes 302 through the pneumatic fittings described above. In some embodiments, tooling may be configured to couple the high volume vacuum to the rear surface 308 of the form tool 206. For example, a suction plate may be configured to secure the form tool 206 to the suction plate and generate the vacuum 502 through the one or more holes 302.

The vacuum 502 may pull the deck 110 toward the form tool 206, such that the back surface 404 of the deck 110 may conform to substantially the same shape as the front surface 306 of the form tool 206. In other embodiments, a vacuum bag may be used to pull the deck 110 toward the form tool 206. For example, the form tool 206 and the deck 110 may be placed in a vacuum bag and the vacuum may be applied to the vacuum bag pulling the deck 110 toward the form tool 206. Once the outer edge 406 of the deck 110 contacts the thin seal along the outer edge 304 of the form tool 206 an airtight seal may be formed between the deck 110 and the form tool 206. The vacuum 502 may then be removed or stopped and the one or more holes 302 may be sealed such that no air may pass back into the area between the deck 110 and the form tool 206. For example, the pneumatic fittings may include one-way valves or a quick-release fitting configured to be closed when not connected to another fitting.

Once the vacuum 502 is removed or stopped, the airtight seal between the back surface 404 of the deck 110 and the front surface 306 of the form tool 206 may maintain the suction force between the deck 110 and the form tool 206 such that the deck 110 may have a contour substantially the same as the contour of the front surface 306 of the form tool 206. The contour of the deck 110 may then be substantially complementary to a contour of the glass 102.

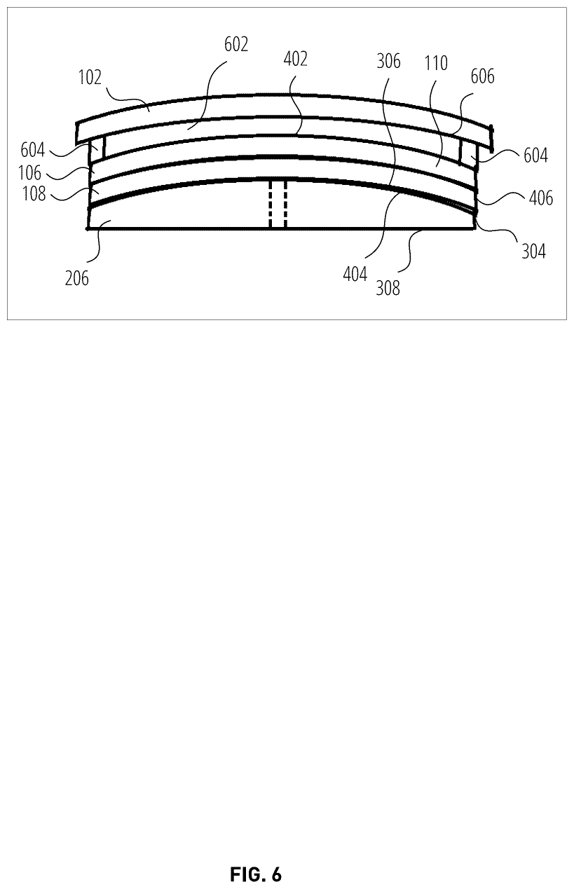

Once the deck 110 is secured to the form tool 206 the glass 102 may be added to the ballistic window assembly as illustrated in FIG. 6. One or more spacers 604 may be positioned between the front surface 402 of the deck 110 and a rear surface 606 of the glass 102. As described above, the front surface 402 of the deck 110 may be a surface of the impact resistant layer 106. In some embodiments, the spacers 604 may be positioned on the outer edge 406 of the front surface 402 of the deck 110 or impact resistant layer 106. The spacers 604 may be positioned on a rear surface 606 of the glass 102 along the border 204 (FIG. 2A). In some embodiments, the spacers 604 may be positioned in multiple different positions on either the rear surface 606 of the glass 102 within the area defined by the border 204 or on the front surface 402 of the deck 110 or impact resistant layer 106.

Once the spacers 604 are positioned the glass 102 may be positioned on the deck 110, such that the border 204 defined on the glass 102 is substantially aligned with the outer edge 406 of the deck 110. The glass 102 and the deck 110 may be oriented such that the rear surface 606 of the glass 102 faces the front surface 402 of the deck 110. In other words, the ballistic glass assembly may be arranged in the following order, the glass 102, the void 602, the impact resistant layer 106, and the polymer sheet layers 108. In some embodiments, additional layers may be present between the glass 102 and the polymer sheet layers 108. For example, additional layers of glass, polymer sheets, or impact resistant materials may be positioned between the glass 102 and the polymer sheet layers 108. In some embodiments, additional layers may be present after the polymer sheet layers 108. For example, additional layers of glass, polymer sheets, or impact resistant materials may be positioned on or after the back surface 404 of the polymer sheet layers 108 or deck 110.

The spacers 604 may define a void 602 between the front surface 402 of the deck 110 and the rear surface 606 of the glass 102. The void 602 may have a height between about 0.005 in (0.127 mm) and about 0.200 in (5.08 mm), such as between about 0.008 in (0.203 mm) and about 0.016 in (0.4064 mm). The spacers 604 may have a lateral dimension (e.g., a dimension transverse to the height of the void) of between about 0.0625 in (1.5875 mm) and about 0.25 in (6.35 mm), such as between about 0.0635 in (1.5875 mm) and about 0.125 in (3.175 mm).

Once the glass 102 and the deck 110 are placed together with the spacers 604 defining the void 602 between the glass 102 and the deck 110, the glass 102 may be secured to the deck 110 with an adhesive material, such as an epoxy. The adhesive material may be configured to form a wall substantially the same height as the spacers 604 and couple the rear surface 606 of the glass 102 to the front surface 402 of the deck 110. In some embodiments, the adhesive material may be configured to be cured through exposure to light or heat, such as a UV curable epoxy or heat curable epoxy. The adhesive material may be positioned between the front surface 402 of the deck 110 and the rear surface 606 of the glass 102 along the outer edge 406 of the front surface 402 of the deck 110 and/or the border 204 on the rear surface 606 of the glass 102.

Once cured the adhesive material may form a substantially rigid wall coupling the glass 102 to the deck 110. The cured adhesive material may enable the spacers 604 to be removed from between the glass 102 and the deck 110 while maintaining the void 602 between the glass 102 and the deck 110. For example, the cured adhesive may act as a spacer defining the void 602 between the glass 102 and the deck 110 after the spacers 604 are removed. In some embodiments, spacers 604 along an outer edge of the 110 may remain within the cured adhesive material forming the wall.

In some embodiments, temporary clamps, such as C-clamps, screw clamps, carriage clamps, bar clamps, spring clamps, etc., may be used to secure the glass 102 to the deck 110 while the adhesive material is positioned and/or cured. Once the adhesive material is cured the temporary clamps may be removed. In some embodiments, the form tool 206 may be removed from the assembly once the adhesive material is cured. For example, the cured adhesive material may be substantially rigid and configured to maintain the contour of the deck 110 relative to the glass 102 by maintaining a rigid connection between the border 204 defined on the glass 102 and the outer edge 406 of the deck 110.

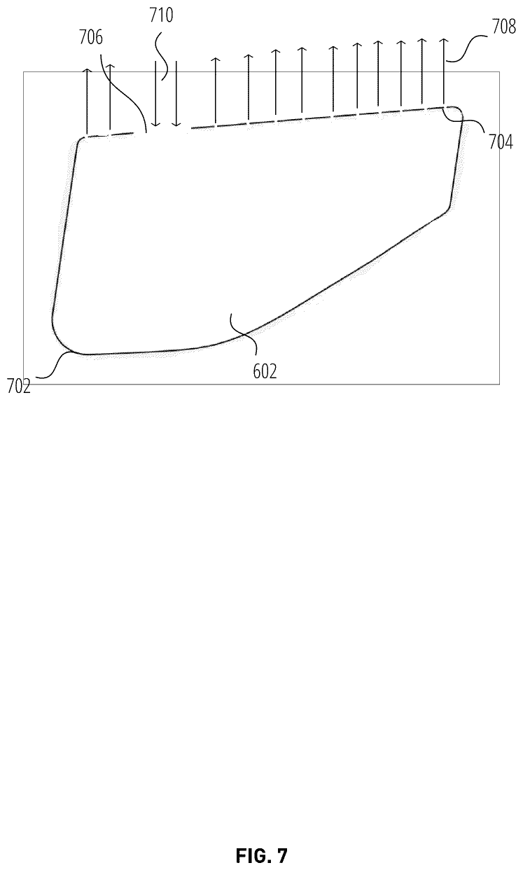

FIG. 7 illustrates an adhesive wall 702 formed by the cured adhesive material. As discussed above, the adhesive wall 702 may define the void 602 between the glass 102 and the deck 110. The adhesive wall 702 may be formed along the border 204 defined on the glass 102, which may coincide with the outer edge 406 of the deck 110.

As illustrated in FIG. 7, the adhesive wall 702 may be substantially continuous along all sides except one side of the border 204. The adhesive wall 702 may be formed from multiple straight portions connected by angled or radiused portions of the adhesive wall 702 that coincide with the lines, angles, and radii of the border 204. One side of the adhesive wall 702 may include a fill aperture 706 and one or more exhaust apertures 704 configured to enable access to the void 602 through the adhesive wall 702. The other walls of the adhesive wall 702 may be configured to form a seal between the glass 102 and the deck 110 (e.g., a water-tight seal, an air-tight seal, etc.).

As illustrated in FIG. 7, the fill aperture 706 and the exhaust apertures 704 may be arranged on the same straight portion of the adhesive wall 702. In some embodiments, the fill aperture 706 and the exhaust apertures 704 may be on different portions of the adhesive wall 702. For example, the fill aperture 706 may be located on a first straight portion of the adhesive wall 702 and the exhaust apertures 704 may be located on a second opposite straight portion of the adhesive wall 702. In some embodiments, the fill aperture 706 may be located on a first portion of the adhesive wall 702 and the exhaust apertures 704 may be located on a second adjacent portion of the adhesive wall 702.

The exhaust apertures 704 may be a series of small apertures through the adhesive wall 702. In some embodiments, the exhaust apertures 704 may be openings through the adhesive wall 702 that are between about 0.03125 in (0.79375 mm) wide and about 0.125 in (3.175 mm) wide, such as about 0.0625 in (1.5875 mm) wide. In some embodiments, the exhaust apertures 704 may be substantially evenly spaced along the associated straight portion of the adhesive wall 702. For example, the exhaust apertures 704 may be spaced at intervals between about 1 in (25.4 mm) and about 6 in (152.4 mm), such as between about 2 in (50.8 mm) and about 4 in (101.6 mm), or about 3 in (76.2 mm). In some embodiments, there may be an exhaust aperture 704 on each end of the associated straight portion of the adhesive wall 702 and no additional exhaust apertures 704 along the straight portion of the adhesive wall 702.

The fill aperture 706 may be a single larger aperture through the adhesive wall 702. In some embodiments, the fill aperture 706 may be an opening through the adhesive wall 702 extending between about 0.5 in (12.7 mm) and about 10 in (254 mm) in length, such as between about 3 in (76.2 mm) and about 8 in (203.2 mm) in length, or about 4 in (101.6 mm) in length. In some embodiments, the fill aperture 706 may include multiple larger apertures through the adhesive wall 702, such as two larger apertures, three larger apertures, etc.

A fill material 710 may be flowed into the void 602 through the fill aperture 706 in the adhesive wall 702. In some embodiments, the fill material 710 may be a clear epoxy resin. For example, the fill material 710 may be a two part urethane resin. In some embodiments, the fill material 710 may be a two part polyester resin. The fill material 710 may be chosen for properties, such as adhesion, clarity, color, tint, etc. In some embodiments, the fill material 710 may be a liquid material that is configured to cure through a chemical reaction resulting from mixing two compounds together. In some embodiments, the fill material 710 may be a liquid material that is configured to cure from exposure to heat and/or UV light.

As the fill material 710 is flowed into the void 602 through the fill aperture 706, the gases and/or fluids that are initially located in the void 602 may exit the void 602 through the exhaust apertures 704 as exhaust material 708. For example, the void 602 may initially be filled with air. The fill material 710 may be flowed into the void 602 through the fill aperture 706. The fill material 710 may displace the air in the void 602. As the air is displaced the air may exit the void 602 through the one or more exhaust apertures 704 as exhaust material 708. The assembly may be positioned in a manner such that the exhaust apertures 704 are positioned at a high point as illustrated in FIG. 7. The fill material 710 may have a density that is greater than the density of the gasses (e.g., air) initially located in the void 602, such that as the fill material 710 is flowed into the void 602 the gasses in the lower portions of the void 602 may be displaced first and forced upwards. As the fill material 710 fills the void 602 the gasses may continue to be displaced upward until the fill material 710 completely fills the void 602 (e.g., the void 602 is substantially free of any other material).

If any gasses remain in the void 602, the gasses may form bubbles within the fill material 710. Any gas bubbles may then be removed from the fill material 710. In some embodiments, the gas bubbles may be removed using concentrated suction, such as a syringe, needle, vacuum tube, etc. In some embodiments, the gas bubbles may be removed and/or prevented using external pressure, such as vacuum pressure on one or more of the exhaust apertures 704 or high pressure at the fill aperture 706.

In some embodiments, the fill aperture 706 may be covered once a volume of fill material 710 sufficient to fill the void 602 has been inserted into the void 602. In some embodiments, only a portion of the fill aperture 706 may be covered such that an open portion of the fill aperture 706 may act as an additional exhaust aperture 704.

Once the void 602 is substantially full of the fill material 710 and substantially free of any other materials, the exhaust apertures 704 and the fill aperture 706 may be sealed. In some embodiments, the exhaust apertures 704 and the fill aperture 706 may be sealed with the fill material 710. For example, the fill material 710 may be cured such that the fill material 710 may solidify substantially sealing the exhaust apertures 704 and the fill aperture 706. In some embodiments, the exhaust apertures 704 and/or the fill material 710 may be sealed with an additional material, such as an adhesive material (e.g., epoxy, etc.), a sealant (e.g., silicone, etc.), an adhesive strip (e.g., tape, etc.), etc.

In some embodiments, the fill material 710 may be cured under vacuum. For example, the ballistic glass assembly may be positioned in a vacuum bag and the fill material 710 may be cured while the assembly is in the vacuum bag. The vacuum bag may be configured to maintain a shape of the ballistic glass assembly during the curing process through the applied vacuum.

In some embodiments, the fill material 710 may be cured through a heating process. For example, the filled assembly may be placed in a furnace or oven for a period of time at a temperature sufficient to cure the fill material 710 in the void 602 of the assembly. In some embodiments, the temperature and/or time period may be selected to ensure pliability of other materials in the assembly, such as the impact resistant layer 106. In some embodiments, the temperature and/or time period may be selected to cure the fill material 710 and/or other elements of the assembly, such as the adhesive materials in the polymer sheet layers 108, etc. The temperature of the furnace may be between about 150° F. (65.556° C.) and about 300° F. (148.889° C.), such as between about 200° F. (93.333° C.) and about 250° F. (121.111° C.) or about 102° F. (93.333° C.). The time period may be between about 30 minutes and about 3 hours, such as between about 1 hour and about 2 hours, or about 1 hour.

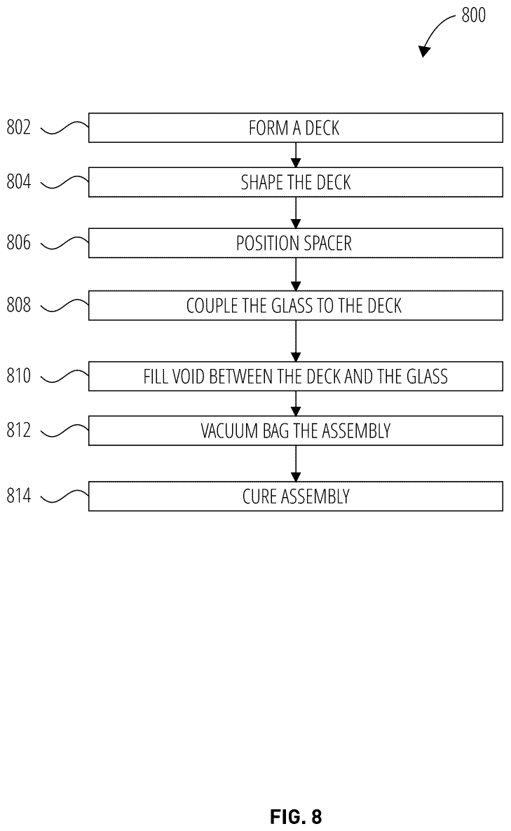

FIG. 8 illustrates a flow chart representative of an additional embodiment of a method of forming a ballistic window assembly 800 in accordance with the present disclosure. Referring also to FIGS. 1-7. As described above, a deck 110 may be formed by layering an impact resistant layer 106 and several polymer sheet layers 108 in act 802.

As described above, the impact resistant layer 106 may be formed from an impact resistant material. In some embodiments, the impact resistant material may be a thermoplastic material, such as a polycarbonate material or an acrylic material (e.g., poly(methyl methacrylate), acrylic glass, etc.).

The polymer sheet layers 108 may be applied to a surface of the impact resistant layer 106. The polymer sheet layers 108 may include one or more layers of a PET film. In some embodiments, the polymer sheet layers 108 may be a double-side adhesive material. For example, the polymer sheet layer 108 may be a pressure sensitive polyester adhesive material.

As described above, the polymer sheet layers 108 and the impact resistant layer 106 may be laminated together using adhesive and applied pressure and/or heat. For example, the applied adhesive may be activated by one or more of pressure and temperature. A heated roller may, such as a nip roller may be used to laminate the polymer sheet layers 108 and/or the impact resistant layer 106 together. In some embodiments, the heat and/or pressure may be applied through another means, such as a flat press, a heated flat press, etc. In some embodiments, the pressure and heat may be applied separately. For example, heat may be applied through a separate heating means, such as a heater, heat gun, furnace, oven, heat lamp, etc., while the pressure may be applied by a press, a roller, roller press, flat press, etc.

Once the deck 110 is formed, the deck 110 may be cut to the desired shape in act 804. The deck 110 may be cut along an outer edge 406 of the deck 110 such that the deck 110 is substantially the same size and shape as a border 204 defined by the window frame as discussed in FIG. 2A. In some embodiments, an inner deck template may be created from the border 204 and used to mark the outer edge 406 of the deck 110, such that the deck 110 may be trimmed to substantially the same size and shape as the border 204. In some embodiments, properties of the border 204, such as size, shape, orientation, dimensions, angles, radii, etc., may be digitally recorded. The properties of the border 204 may then be used to control a computer controlled cutting mechanism, such as a water jet, laser cutter, CNC machine, wire EDM, etc., to cut the deck 110 to substantially the same size and shape as the border 204.

After the deck 110 is formed and shaped a spacer may be positioned on a surface of the deck 110 or the glass 102 in act 806. The spacer may be configured to maintain a separation between the deck 110 and the glass 102 when the glass 102 is added to the stack of materials forming the deck 110. The separation between the deck 110 and the glass 102 may define a void 602 between the deck 110 and the glass 102. In some embodiments, the spacer may be pressure sensitive adhesive film, such as a PET adhesive film. The spacer may be a thin strip of a spacer film having a width between about 0.0625 in (1.588 mm) and about 0.25 in (6.35 mm), such as about 0.125 in (3.175 mm). The spacer may have a thickness of between about 10 thousandths of an inch (mil) (0.254 mm) and about 50 mil (1.27 mm), such as between about 10 mil (0.254 mm) and about 30 mil (0.762 mm), or between about 15 mil (0.381 mm) and about 21 mil (0.533 mm). In some embodiments, the spacer may be multiple temporary spacers, such as plastic wedges or tape.

Once the spacer film is positioned on a surface of the deck 110 or the glass 102, the glass 102 may be coupled to the deck 110 in act 808. Once the glass 102 and the deck 110 are placed together with the spacer film defining the void 602 between the glass 102 and the deck 110, the glass 102 may be coupled to the deck 110 with an adhesive material, such as an epoxy. The adhesive material may be configured to form a wall substantially the same height as the spacer film and couple the rear surface 606 of the glass 102 to the front surface 402 of the deck 110. As described above, the front surface 402 of the deck 110 may coincide with a surface of the impact resistant layer 106. In some embodiments, the adhesive material may be configured to be cured through exposure to light or heat, such as a UV curable epoxy or heat curable epoxy. The adhesive material may be positioned between the front surface 402 of the deck 110 and the rear surface 606 of the glass 102 along the outer edge 406 of the front surface 402 of the deck 110 and/or the border 204 on the rear surface 606 of the glass 102.

The adhesive material may be cured to form an adhesive wall similar to the adhesive wall 702 described above in FIG. 7. The adhesive wall 702 may include a fill aperture 706 and one or more exhaust apertures 704 on at least one portion of the adhesive wall 702. The adhesive wall 702 may create a seal between the deck 110 and the glass 102 in all areas except the fill aperture 706 and the exhaust apertures 704. As described above, the adhesive wall 702 may define the void 602 between the deck 110 and the glass 102.

In some embodiments, the deck 110 may remain substantially straight (e.g., not matching the contours of the glass 102), such that the void 602 may be substantially larger than the void 602 would be if the deck 110 conformed to the contours of the glass 102. A fill material 710 may be flowed into the void 602 through the fill aperture 706 in act 810. The fill material 710 may be flowed in until there is sufficient fill material 710 in the void 602 to substantially fill the void 602 (e.g., free from all other materials) once the deck is conformed to the contours of the glass 102. The void 602 may only be partially full of the fill material 710 before the deck 110 is conformed to the contours of the glass 102. As described above, the fill material 710 may be a clear epoxy resin. For example, the fill material 710 may be a two part urethane resin. In some embodiments, the fill material 710 may be a two part polyester resin. The fill material 710 may be chosen for properties, such as adhesion, clarity, color, tint, etc. In some embodiments, the fill material 710 may be a liquid material that is configured to cure through a chemical reaction resulting from mixing two compounds together. In some embodiments, the fill material 710 may be a liquid material that is configured to cure from exposure to heat and/or UV light.

The fill aperture 706 may be substantially closed once the fill material 710 is flowed into the void 602. For example, the fill aperture 706 may be covered such that only smaller exhaust apertures 704 remain where the fill aperture 706 was located. In some embodiments, the fill aperture 706 may be completely filled in. In some embodiments, the fill aperture 706 may be filled in using the adhesive material used to form the adhesive wall 702 described above. In some embodiments, the fill aperture 706 may be covered using a sealing material, such as tape, silicone, spacer film, etc.

Once the void 602 is substantially full of the fill material 710, the window assembly may be placed in a vacuum bag in act 812. The vacuum bag may be configured to form a substantially air-tight seal around the window assembly. Once the window assembly is placed in the vacuum bag and the vacuum bag is sealed, a vacuum may be generated to remove air from the vacuum bag placing the window assembly under a negative pressure. The negative pressure may cause the deck 110 to approach the glass 102 substantially matching the contours of the glass 102. As the deck 110 approaches the glass 102 excess fill material 710 within the void 602 may flow out of the exhaust apertures 704. The negative pressure within the vacuum bag may be maintained at greater than 24 inches of mercury (inhg) (609.6 millimeters of mercury (mmhg)) throughout the curing process.

A surface of the window assembly may be covered with a release fabric (e.g., low tack film) configured to substantially prevent the fill material 710 from covering the outer surfaces of the widow assembly after the fill material 710 flows out of the exhaust apertures 704. In some embodiments, a breather cloth (e.g., bleeder cloth) may be positioned over the exhaust apertures 704, such that any fill material 710 flowing out of the exhaust apertures 704 may be substantially absorbed by the breather cloth and substantially prevented from covering the outer surfaces of the window assembly. A surface of the window assembly may further include an incompressible material (e.g., peel ply) configured to allow vacuum to penetrate to every part of the vacuum bag.

The window assembly may be cured in act 814. The window assembly may be cured while being maintained under the negative pressure within the vacuum bag. In some embodiments, the vacuum bag may be maintained at the negative pressure for a period of time at room temperature allowing the fill material 710 to cure. For example, the vacuum bag may be maintained at the negative pressure for at least 24 hours, such as between about 24 hours and about 5 days. In some embodiments, the window assembly in the vacuum bag under the negative pressure may be placed in an oven or a furnace for a period of time allowing the fill material 710 to cure. In some embodiments, the temperature and/or time period may be selected to cure the fill material 710 or other elements of the assembly, such as the adhesive materials in the polymer sheet layers 108, etc. The temperature of the furnace may be between about 150° F. (65.556° C.) and about 300° F. (148.889° C.), such as between about 200° F. (93.333° C.) and about 250° F. (121.111° C.) or about 200° F. (93.333° C.). The time period may be between about 30 minutes and about 3 hours, such as between about 1 hour and about 2 hours, or about 1 hour.

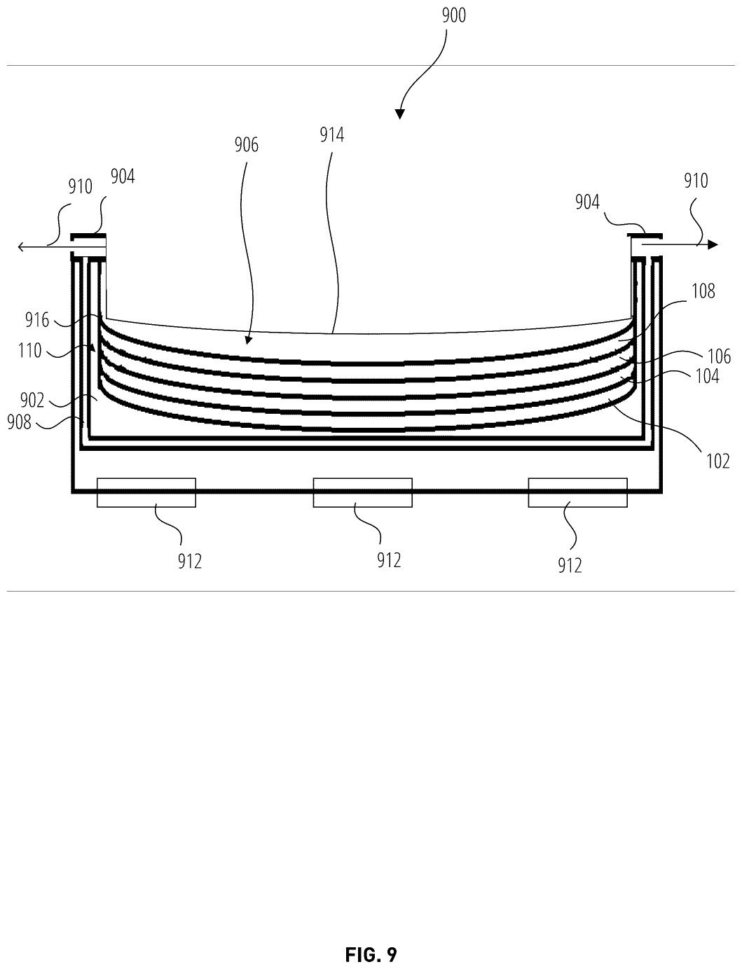

In some embodiments, the ballistic glass assembly 100 may be formed using mold assembly, such as a vacuum mold. For example, a vacuum mold may enable a user to mass produce multiple ballistic glass assemblies 100 using the same mold, such that each ballistic glass assembly 100 is substantially the same. Thus, if the user is producing multiple ballistic glass assemblies for the same model of car, such as a fleet of cars, etc., the user may use a vacuum mold such to produce the ballistic glass assemblies 100 more efficiently. FIG. 9 illustrates an embodiment of a vacuum mold 900 that may be used to form the ballistic glass assembly 100.

The vacuum mold 900 may include a mold 902, a vacuum plate 904, and a flexible upper wall 914. The mold 902 and the flexible upper wall 914 may define a mold cavity 906. The mold 902 have a complementary shape to the glass 102. The ballistic glass assembly 100 may be built up in the mold cavity 906. For example, the glass 102 may be placed against a bottom surface of the mold 902 and the adhesive layers 104, impact resistant layers 106, and polymer sheet layers 108 may be built up on the exposed surface of the glass 102 as discussed above with respect to FIG. 8. As described in FIG. 8, the adhesive layer 104, impact resistant layers 106, and polymer sheet layers 108 may not immediately conform to a shape of the glass 102.

The vacuum mold 900 may be placed under a positive outside pressure. The positive outside pressure may cause the flexible upper wall 914 to contact the top layer of the deck 110, such as the polymer sheet layers 108 pressing the adhesive layer 104, impact resistant layers 106, and the polymer sheet layers 108 into the mold 902. In some embodiments, an upper edge 916 of the deck 110 may include soft edge, such as a rubber edge, rounded edge, etc. The soft edge may be configured to substantially prevent the upper edge 916 of the deck 110 from breaking or cutting the flexible upper wall 914. The flexible upper wall 914 may be formed from a material similar to a vacuum bag material. Under the positive outside pressure the flexible upper wall 914 may cause the adhesive layer 104, impact resistant layers 106, and the polymer sheet layers 108 to conform to the shape of the mold 902. In some embodiments, the positive outside pressure may be generated by an autoclave.

The mold 902 may include one or more vacuum ports 908. The vacuum ports 908 may be operatively coupled to the mold cavity 906. In some embodiments, the vacuum ports 908 may also be operatively coupled to the vacuum plate. A vacuum 910 may be operatively coupled to the vacuum ports 908. For example, the vacuum 910 may be coupled to the vacuum plate 904 such that the vacuum 910 may generate a vacuum in the mold cavity 906 through the vacuum ports 908. The vacuum 910 may thus create a negative pressure within the mold cavity 906 such that the upper flexible wall 904 creates additional pressure on the adhesive layer 104, impact resistant layers 106, and the polymer sheet layers 108 conform to the shape of the glass 102 and/or to evacuate any air trapped between the deck 110 and the mold 902. The ballistic glass assembly 100 may then be cured in the vacuum mold 900. As described above, curing the ballistic glass assembly 100 may include applying heat and/or sustaining the negative pressure for an extended period of time. For example, the vacuum mold 900 may be placed under high pressure and/or heat, such as in an autoclave, to cure the ballistic glass assembly. In some embodiments, the entire vacuum mold 900 may be heated, such as in an oven, with a heater, etc. In some embodiments, the vacuum mold 900 may include a heating element configured to heat the vacuum mold 900 and/or the ballistic glass assembly within the vacuum mold 900, during the curing process. In some embodiments, the mold 902 may have a thickness that is substantially the same at each point within the mold, such that heat transfer through the mold 902 to the deck 110 is substantially uniform.

In some embodiments, the vacuum mold 900 may be used to form the deck 110 without the glass 102. For example, the deck 110 may be assembled within the mold cavity 906 as if the surface of the mold 902 was the glass 102. Thus the impact resistant layers 106 and the polymer sheet layers 108 may be built up on the surface of the mold 902. The vacuum 910 may be applied causing the deck 110 to conform to the shape of the glass 102 as defined by the mold 902. The deck 110 may be cured while under the negative pressure caused by the vacuum 910. Once cured the deck 110 may maintain the shape defined by the mold 902, such that the deck 110 may be removed from the vacuum mold 900 and applied to the glass 102 with an adhesive, such as a liquid adhesive or an adhesive film in any of the manners described above.

In some embodiments, the mold 902 may include one or more supports 912. The supports 912 may be configured to strengthen the mold 902. For example, strategically placed supports 912 in a large mold 902 may strengthen the mold 902 to prevent the mold 902 from breaking or deforming. In some embodiments, the supports 912 may be configured to interface with other components, such as tooling, transportation devices, etc. For example, in an assembly plant, the mold 902 may be coupled to a transportation device, such as a conveyor or track that may move the mold between stations during the process of forming the ballistic glass assembly 100. The stations may include a lay-up station where the layers of the deck 110 are built up in the mold cavity 906, a vacuum station where the vacuum 910 is applied to the vacuum mold 900, and a curing station where the ballistic glass assembly 100 is cured.

Embodiments of the present disclosure may enable ballistic glass to be better fit in an automobile. For example, embodiments of the present disclosure may enable the creation of curved ballistic glass having contours substantially matching the contours of automobile glass. Embodiments, of the present disclosure may enable ballistic glass that is lighter weight and/or thinner than traditional ballistic glass. Lighter weight and/or thinner ballistic glass may reduce and/or eliminate the modifications to the associated automobile necessary to fit the ballistic glass. Reducing and/or eliminating the modifications may reduce the cost of adding ballistic protection to an automobile. Furthermore, reducing the weight added by the ballistic glass may improve fuel economy and/or power to weight ratios of the associated automobile.

The following examples serve to explain embodiments of the disclosure in more detail. These examples are not to be construed as being exhaustive or exclusive as to the scope of the disclosure.

### EXAMPLES

### Example 1

A ballistic glass assembly may be constructed on an OEM automobile window having a thickness of between about 0.14 in (3.556 mm) and about 0.200 in (5.08 mm). A deck may be formed from a first polycarbonate sheet having a thickness of 0.125 in (3.175 mm), three layers of PET adhesive film each having a thickness of 0.016 in (0.4064 mm) and a second polycarbonate sheet having a thickness of 0.125 in (3.175 mm). The first polycarbonate sheet and the second polycarbonate sheet may be separated by the three layers of PET adhesive film. The deck may be positioned approximately 0.055 in (1.397 mm) from the back side of the OEM automobile window forming a void between the deck and the back side of the OEM automobile window. The deck may be oriented such that a front surface of the first polycarbonate sheet is facing the back side of the OEM window. The void may be filled with a liquid laminate comprising a clear epoxy resin. When cured the liquid laminate may form a laminate layer that is about 0.055 in (1.397 mm) thick between the back side of the OEM automobile window and the front surface of the first polycarbonate sheet. The total thickness of the ballistic glass assembly may be about 0.553 in (14.0462 mm).

### Example 2

A ballistic glass assembly may be constructed on an OEM automobile window having a thickness of 0.200 in (5.08 mm). A deck may be formed from a polycarbonate sheet having a thickness of 0.125 in (3.175 mm) and six layers of PET adhesive film each having a thickness of 0.016 in (0.4064 mm). The six layers of PET adhesive film may all be applied on a back side of the polycarbonate sheet, with a first layer of the PET adhesive film being applied directly to a back side surface of the polycarbonate sheet and the remaining layers of the PET adhesive film being applied over the first layer of the PET adhesive film. The deck may be positioned approximately 0.055 in (1.397 mm) from the back side of the OEM automobile window forming a void between the deck and the back side of the OEM automobile window. The deck may be oriented such that a front surface of the polycarbonate sheet is facing the back side of the OEM automobile window and the six layers of PET adhesive film are on an opposite side of the polycarbonate sheet from the OEM automobile window. The void may be filled with a liquid laminate comprising a clear epoxy resin. When cured the liquid laminate may form a laminate layer that is about 0.055 in (1.397 mm) thick between the back side of the OEM automobile window and the front surface of the first polycarbonate sheet. The total thickness of the ballistic glass assembly may be about 0.476 in (12.090 mm).

### Example 3

A ballistic glass assembly may be constructed on an OEM automobile window having a thickness of 0.200 in (5.08 mm). A deck may be formed from a polycarbonate sheet having a thickness of 0.125 in (3.175 mm) and six layers of PET adhesive film each having a thickness of 0.016 in (0.4064 mm). The six layers of PET adhesive film may all be applied on a back side of the polycarbonate sheet, with a first layer of the PET adhesive film being applied directly to a back side surface of the polycarbonate sheet and the remaining layers of the PET adhesive film being applied over the first layer of the PET adhesive film. A double-side adhesive PET film having a thickness of 0.016 in (0.4064 mm) may be applied to a back surface of the OEM automobile window. The deck may be oriented such that a front surface of the polycarbonate sheet is facing the back side of the OEM automobile window and the six layers of PET adhesive film are on an opposite side of the polycarbonate sheet from the OEM automobile window. The deck may then be coupled to the OEM automobile window with the double-side adhesive PET, such that the double-side adhesive PET is coupled between the back surface of the OEM automobile window and the front surface of the polycarbonate sheet. The total thickness of the ballistic glass assembly may be about 0.437 in (11.10 mm).

### Example 4

A ballistic glass assembly may be constructed on a first OEM automobile window having a thickness of 0.200 in (5.08 mm). A deck may be formed from a second OEM automobile window having a thickness of 0.200 in (5.08 mm), a liquid laminate layer comprising a clear epoxy resin having a thickness of 0.055 in (1.397 mm), a polycarbonate sheet having a thickness of 0.125 in (3.175 mm) and two layers of PET adhesive film each having a thickness of 0.016 in (0.4064 mm). The two layers of PET adhesive film may both be applied on a back side of the polycarbonate sheet, with a first layer of the PET adhesive film being applied directly to a back side surface of the polycarbonate sheet and the second layer of the PET adhesive film being applied over the first layer of the PET adhesive film. The polycarbonate sheet may be coupled to a back surface of the second OEM automobile window with the liquid laminate layer. The deck may be positioned approximately 0.055 in (1.397 mm) from the back side of the first OEM automobile window forming a void between the deck and the back side of the first OEM automobile window. The deck may be oriented such that a front surface of the second OEM automobile window is facing the back side of the first OEM automobile window and the poly carbonate sheet and two layers of PET adhesive film are on an opposite side of the second OEM automobile window from the first OEM automobile window. The void may be filled with a liquid laminate comprising a clear epoxy resin. When cured the liquid laminate layers may form laminate layers that are each about 0.055 in (1.397 mm) thick. The total thickness of the ballistic glass assembly may be about 0.6075 in (15.4305 mm).

### Example 5

A ballistic glass assembly may be constructed on a first OEM automobile window having a thickness of 0.200 in (5.08 mm). A deck may be formed from a second OEM automobile window having a thickness of 0.200 in (5.08 mm) and four layers of PET adhesive film each having a thickness of 0.016 in (0.4064 mm). The four layers of PET adhesive film may both be applied on a back side of the second OEM automobile window, with a first layer of the PET adhesive film being applied directly to a back side surface of the second OEM automobile widow and the remaining layers of the PET adhesive film being applied over the first layer of the PET adhesive film. The deck may be positioned approximately 0.055 in (1.397 mm) from the back side of the first OEM automobile window forming a void between the deck and the back side of the first OEM automobile window. The deck may be oriented such that a front surface of the second OEM automobile window is facing the back side of the first OEM automobile window and the four layers of PET adhesive film are on an opposite side of the second OEM automobile window from the first OEM automobile window. The void may be filled with a liquid laminate comprising a clear epoxy resin. When cured the liquid laminate layer may form a laminate layer that is about 0.055 in (1.397 mm) thick. The total thickness of the ballistic glass assembly may be about 0.519 in (13.183 mm).

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A method of manufacturing ballistic glass comprising:
creating a form tool configured to match a shape and contour of a piece of glass;
forming a deck comprising multiple layers, wherein at least one layer comprises a polyethylene terephthalate (PET) material;
matching a contour of the deck to a contour of the piece of glass by connecting the deck to the form tool with a high volume vacuum;
coupling the piece of glass to the deck with an adhesive; and
forming a void between the piece of glass and the deck, the void defined by the adhesive.

2. The method of claim 1, wherein at least one layer of the deck comprises an impact resistant layer.

3. The method of claim 2, wherein the impact resistant layer comprises a polycarbonate material.

4. The method of claim 1, further comprising defining a void between the piece of glass and the deck with an adhesive wall.

5. The method of claim 4, filling the void with a liquid laminate material.

6. The method of claim 5, wherein the liquid laminate material comprises a clear resin.

7. The method of claim 5, further comprising curing the liquid laminate material.

8. The method of claim 7, wherein curing the liquid laminate material comprises heating the liquid laminate material, the piece of glass, and the deck to between about 150° F. (65.556° C.) and about 300° F. (148.889° C.) after filling the void with the liquid laminate material.
